(19) United States
(12) Patent Application Publication
(10) Pub. No.: US 2016/0039081 A1
(43) Pub. Date: Feb. 11, 2016

(54) Tool having a Controllable Cooling Means

(71) Applicant: Robert Bosch GmbH, Stuttgart (DE)

(72) Inventors: Eberhard Ruhs, Sulzbach/Murr (DE); Andreas Scharfenberg, Murrhardt (DE)

(21) Appl. No.: 14/818,423

(22) Filed: Aug. 5, 2015

(30) Foreign Application Priority Data
Aug. 5, 2014 (DE) 10 2014 215 361.1

(51) Int. Cl. B25F 5/00

(52) U.S. Cl. CPC B25F 5/008

(57) ABSTRACT

An electrically operated tool appliance comprises a rotatable tool head, an electric motor drive configured to drive the rotatable tool head, a control system configured to control the electric motor drive, an energy supply configured to supply the electric motor drive with electrical energy, and a first cooling mechanism configured to cool the electric motor drive and/or the control system. The first cooling mechanism defines a cooling capacity configured to be controlled independently of a rotational speed of the electric motor drive.

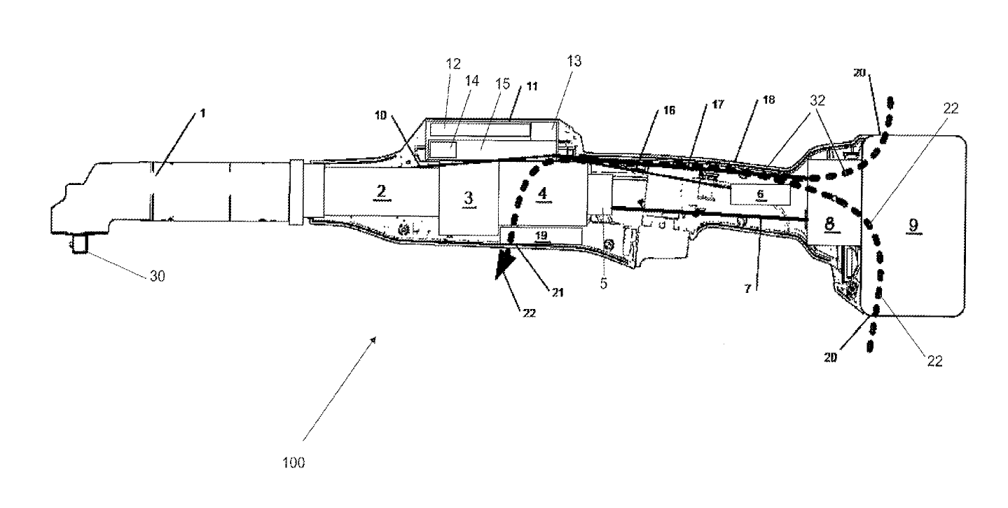

This application claims priority under 35 U.S.C. §119 to patent application no. DE 10 2014 215 361.1, filed on Aug. 5, 2014 in Germany, the disclosure of which is incorporated herein by reference in its entirety.

### BACKGROUND

The present disclosure relates to a tool appliance, and in particular to a screwdriver, or blind-rivet setting device. Some tool appliances include battery operated tool appliances such as battery operated hand-held screwdrivers. Such appliances have long been known from the prior art. Such tools are used, for example, in industry, such as, for example, in the automobile industry, for tightening and loosening screws.

In this case, in the prior art, there arises the problem that such tools frequently have to be switched off after relatively short operating times, or that only relatively long cycle times can be run, because of heat. In the case of such appliances, it is known that they have electric motors that have a fan propeller on the motor shaft. In these cases there arises the problem that ventilation of the motor can be ensured only for as long as the motor is operating at a sufficient rotational speed. Under normal conditions, this is sufficient since, under normal conditions, it is particularly at high rotational speeds that high heat outputs occur.

It may be the case, however, for example in the field of the automobile industry, that high thermal energies are also released, or have to be removed, even in the case of low rotational speeds, and in particular when operating under load.

### SUMMARY

The present disclosure is based on the object of increasing the on-time of such appliances in order that shorter cycle times can be run with the screwdrivers in the case of a customer such as, for example, the automobile industry. To be solved, in particular, is the problem that, for example in the case of screwing, usually in the final tightening at low rotational speeds, the most heat is produced immediately before the motor is switched off. In particular, removal of this heat is a further object of the disclosure.

Furthermore, in the appliance, heat is produced not only in the motor itself, but also additionally in the power electronics, the control system and possibly also in a battery or rechargeable batter. This heat, likewise, has to be removed.

Particularly in the case of devices that have plastic housings, however, it is often the case that outward removal of heat is possible only to a very limited extent, since the plastic housing is an insulator. Therefore, in this respect also, it is a further object of the disclosure to improve the removal of heat.

These objects are achieved according to the disclosure. Advantageous embodiments and further developments are the subject matter of the claims.

An electrically operated tool appliance has a rotatable tool head, or a rotatable tool element, and has an electric-motor drive means for driving the tool head. Furthermore, the tool appliance has a control-system means for controlling the electric-motor drive means, and has an energy supply means for supplying at least the drive means with electrical energy. Furthermore, the tool appliance has a first cooling means for cooling the drive means and/or the control-system means. Preferably in this case, the tool head, or the tool element, can be rotated about a predefined rotation axis that is preferably fixed in relation to the appliance.

According to the disclosure, a cooling capacity of the cooling means can be controlled independently of a rotational speed of the electric-motor drive means. In contrast to the prior art, it is therefore proposed to provide at least one cooling means that is not coupled to the rotational speed of the drive means. It is thereby also possible to achieve a very good cooling capacity in the case of a low rotational speed, or even when a motor is at a standstill. This cooling means can therefore preferably also be controlled independently of an actuation of a starting switch of the tool appliance.

In the case of a further advantageous embodiment, the tool appliance has a rotary shaft that is disposed between the drive means and the tool head.

Advantageously, differing tools can be mounted on to the tool head, such as, for example, differing types of screwing tools. Advantageously, the appliance has a switching device for actuating the drive means. In this case, this switching means may be suitable, not only for switching the drive means on and off, but preferably also for controlling a rotational speed of the drive means.

In the case of a further advantageous embodiment, the tool appliance has a housing, at least the drive means and the control-system means, in particular, being integrated into this housing. Advantageously, the housing is a plastic housing.

In the case of a further advantageous embodiment, the device has an indication means, via which information or data can be output to a user, for instance data designating a screwing operation to be performed at a present time or, alternatively, data informing the user about a mounted-on screwing tool.

In the case of a further advantageous embodiment, the appliance has an input means for inputting data to the appliance, and in particular to the control means. Thus, for example, via this input means the user can define parameters such as, for instance, a screwing speed, a torque to be applied, and the like.

In the case of a further advantageous embodiment, the tool means has a communication means, by means of which the tool appliance can communicate with other devices. Advantageously, this is a communication means that operates wirelessly.

In the case of a further advantageous embodiment, the tool appliance has a transmission means, which is disposed between the drive means and the tool head. Advantageously, this is a reducing transmission that reduces the rotational speed of the drive means.

In the case of a further advantageous embodiment, the appliance has a measuring means, and in particular a measuring means that is suitable and provided for determining parameters such as, for instance, a torque being applied at a present time, that are characteristic of a work operation such as, for instance, a screwing operation. Thus, advantageously, the tool appliance is a measuring appliance.

Moreover, the tool appliance may also have a measuring device that determines a rotary position of the drive means and/or of the tool head.

In the case of a further advantageous embodiment, the energy supply means is a battery, or rechargeable battery. Moreover, however, the tool appliance could also be connected to an electric supply mains, this being both for the purpose of changing the rechargeable battery and operating the drive means.

Advantageously, the cooling means has a ventilation means that generates an air flow, at least through regions of the tool appliance. In the case of this design, therefore, the cooling is effected by means of air flowing through, i.e. in the manner of an air cooling system. It would also be possible to provide other cooling systems, however, such as, for example, in the form of a Peltier element or the like. Preferably, the cooling means is variable in its cooling capacity. This can be effected, in particular, by means of a variable rotational speed of the ventilation means.

In the case of a further advantageous embodiment, the cooling means has air inlet openings and air outlet opening for cooling air, and at least one flow channel for the cooling air is realized between the air inlet openings and the air outlet openings. It is thus proposed here that the cooling air be routed, at least portionally, through the drive means and/or the control-system means, in order to cool these components. Advantageously, in a direction of flow of the air, the ventilation means is disposed downstream in respect of the drive means and/or the control-system means. This means that the ventilation means sucks the cooling air to a certain extent through the elements to be cooled.

In the case of a further advantageous embodiment, the air inlet openings and air outlet openings are located in regions of the tool appliances that cannot be covered by a user's hand or by an item of clothing. Thus, for example, the tool means may have a handle element, and the respective air outlet and air inlet openings may be disposed in such a manner that, when this handle element is gripped, in each case no regions of the gripping hand can cover the air outlet openings or air inlet openings. In addition, depending on a usual position of the tool means, the air outlet openings and the air inlet openings can be disposed at locations that are also not covered by an item of clothing of the user holding the tool appliance.

In the case of a further advantageous embodiment, this flow channel is configured in such a manner that the cooling air can be used both to cool the drive means and to cool the control-system means. It is possible in this case for the cooling air to be routed first through the drive means or the control-system means, and then through the control-system means or the drive means. Preferably, the cooling air is routed first through the control-system means, and then through the drive means.

Advantageously, it is then also conceivable for the flow channel to be disposed in such a manner that the air also flows through regions of a rechargeable battery, or a battery, for operating the appliance. In the case of this embodiment, the air inlet openings are preferably disposed in a region of the energy source, or the rechargeable battery, of the appliance. Preferably, the flow channel is configured in such a manner that the cooling air also serves to cool the energy supply means.

In this case, preferably at least one first air inlet opening is disposed, and preferably a plurality of air inlet openings are disposed, in a first region of the appliance, and at least one second air inlet opening is disposed, and preferably a plurality of second air inlet openings are disposed, in a second region of the appliance, this first region and this second region being spaced apart from each other. Thus, these regions could be disposed in differing regions of a housing of the appliance.

In the case of a further advantageous embodiment, outlet openings are disposed in the region of the drive means. In this way, a length of the flow channel can be minimized, and efficient cooling of all cooling-relevant components can nevertheless be provided.

In the case of a further advantageous embodiment, the tool appliance has a further cooling means for cooling at least a drive means. Advantageously, the two cooling means are operated independently of each other.

In the case of a further advantageous embodiment, the further cooling means has a cooling element that is coupled to a drive shaft. Thus, for example, a fan propeller may be disposed on the drive shaft. It would also be possible, however, for such a fan propeller to be disposed at other rotatable regions of the tool appliance.

Preferably, the housing of the appliance is configured to promote flow, in such a manner that the air flow is routed through the rechargeable battery, the electronics and the motor. In the case of a further advantageous embodiment, the tool appliance is selected from a group of tool appliances that includes screwdrivers and rivet setting devices, in particular blind-rivet setting devices. Preferably, the tool appliance is a portable, or mobile, appliance, and in particular is an appliance that can be operated without cable connections.

In the case of a further advantageous embodiment, the cooling means has a control-system means that controls a cooling capacity of the cooling means in dependence on at least one operating parameter of the tool appliance. It is thus possible, for example, for the appliance to have an intelligent system of control of the cooling means, or of the fan, on the basis of screwing data, temperature data, load profiles, etc.

In other words, preferably, the operating parameters are selected from a group of operating parameters that includes a temperature of the drive means, a temperature of the control-system means, a temperature of the energy supply means, a rotational speed of the drive means, a motor output power, an actual torque, a setpoint torque, and the like. A plurality of these parameters may also be used for control. In the case of a further advantageous embodiment, the tool appliance has at least one temperature measuring means that determines a temperature of at least one component of the appliance.

Thus, for example, a temperature measuring means may be provided for measuring a temperature of the drive means. Moreover, a temperature measuring means may be provided for measuring a temperature of the control-system means. There may also be a temperature measuring means for determining an external temperature of the appliance. Moreover, there may also be further measuring means that determine, for example, a present torque or the like.

Furthermore, it would also be possible for the appliance to have a plurality of temperature measuring means, in order to measure, in particular, both temperatures of the control-system means and temperatures of the drive means. In the case of a further advantageous embodiment, it would also be possible for there to be a switching device, by means of which the flow paths of the cooling medium can be changed. It would thus be possible, for example, that—when a higher cooling demand occurs at the drive means, or at the electric motor—the flow path of the cooling air, in particular inside the housing, can be controlled in such a manner that the drive means, or the motor, is for the most part cooled. For this purpose, valves, flaps or other valve means may be provided in the flow channel.

Preferably, the cooling means is therefore a cooling means that can be controlled by closed-loop control, which can be controlled, in particular in respect of its capacity, for example the rotational speed of a fan ventilator, by closed-loop control.

The present disclosure makes it possible to achieve a greater on-time of the tool appliance. Moreover, it is also possible to achieve a lower, uniform and homogeneous temperature level inside the tool appliance, and also to increase the service life. Moreover, it is also possible avoid switch-off of the tool appliance during a screwing operation, in particular as a result of excessive temperature, such that, in this way, the process reliability of the tool appliance is also increased. Moreover, it is also possible to dispense with the necessity of a replacement screwdriver in a production line, which is often present in the prior art. In this way, a further reduction in costs can be achieved. It is also conceivable that the tool appliance has a greater performance overall, since the problem of cooling is solved more successfully than in the prior art. Moreover, a higher power density than in the case of a tool, or screwdriver, according to the prior art is also possible.

Further advantages and embodiments are given by the description, claims and appended drawing.

### BRIEF DESCRIPTION OF THE DRAWING

The FIGURE shows a schematic representation of a tool appliance according to an embodiment of the disclosure.

### DETAILED DESCRIPTION

The FIGURE shows a schematic representation of a tool appliance 100 according to the disclosure. In this case, this tool appliance 100 has an angle head 1, disposed on which, in turn, there is a rotatable tool head, or rotatable tool element 30. This rotary element in this case is driven by a drive means 4, i.e. an electric motor, via a measuring shaft 2 and a transmission 3. The reference 5 in this case denotes a rotary position transducer, or angle transducer, which serves to control the drive means.

The reference 11 denotes a control and display unit, by means of which the tool appliance can be controlled by a user. The reference 12 in this case relates to an indication means such as, for instance a display, via which data can be output to the user. Moreover, other indication elements may also be provided, and for example also alarm output elements, such as loudspeakers and the like.

The reference 13 denotes an input means, via which the user of the tool appliance can input data. For example, this may be a keypad.

The reference 14 denotes a communication means such as, for example, a radio module, by means of which the appliance can communicate wirelessly with other devices such as, for example, a central computer. The reference 15 denotes control electronics for controlling the drive means. On the drive shaft 2, which in this case is a measuring shaft, there may be a measuring element (not represented in detail) that measures, for example, a torque of the tool appliance. This measuring element may be connected to the control means 15 via a connecting line.

The reference 10 relates to a connecting line, by means of which the measuring means (not shown) disposed on the shaft 2 is connected to the control means 15. The reference 16 denotes a further connecting line, via which the control means 15, or the electric motor 4, may be connected to a buffering capacitor 6.

The reference 7 denotes a supply line for supplying energy to the drive means 4. The reference 8 relates to a control-system means, in the form of drive electronics, that controls the supply of power to the electric motor. Finally, the reference 9 denotes an energy storage device such as, for instance, a rechargeable battery, which serves to supply energy to the drive means. The broken-line arrow 22 denotes an air stream, which serves to cool the appliance. It can be seen that this air stream, starting from inlet openings 20 disposed in the region of the rechargeable battery 9, is routed through a region of the housing as far as outlet openings 21.

The reference 19 denotes the cooling means for cooling the drive means 4, the rechargeable battery 20 and the control-system means 8. Here, this cooling means has a fan, or a ventilator means, which here sucks the cooling air through the housing. Here, this cooling means is disposed so as to be directly adjacent to the drive means 4. In this way, the flow paths for the cooling air can be kept short. Moreover, the cooling means 19 can also be controlled, for instance by the control means 15. In this case, the cooling capacity can be controlled in dependence on one or more measured operating parameters such as, in particular, a temperature of the drive means 4 and/or of the control-system means 8. The drive means is preferably an EC motor.

The reference 32 denotes, in a general schematic manner, a flow channel for the cooling air that extends through the housing 19. In this case, portions of this flow channel also extend through the drive means and/or the control-system means and/or the energy supply means, or the rechargeable battery.

In this case, this air flow serves both to cool the drive electronics and to cool the drive means 4. Moreover, the air flow can also be directed such that regions of the rechargeable battery 9 are cooled, as well as, if necessary, also other regions such as, for instance, the control means 15. The reference 18 denotes a housing of the appliance 100 in which the above-mentioned elements, such as, for instance, the drive means 4, are accommodated. This housing is preferably composed of an electrically non-conducting material, and particularly preferably of a plastic.

The reference 17 relates to a line connection that connects the control-system means 8, i.e. the power electronics, to the control means 15. Between the power electronics, or the control-system means 8, and the drive means 4, the cooling air is preferably routed along a rectilinear path.

The applicant reserves the right to claim as essential to the disclosure all features that are disclosed in the application documents, to the extent that they are novel in comparison with the prior art, either individually or in combination. It is pointed out that features that may be advantageous per se have also been described in the figure. Persons skilled in the art will immediately identify that a particular feature described in a figure may also be advantageous without the adoption of further features from this figure.

### LIST OF REFERENCES

1 angle head
2 measuring shaft/drive shaft
3 transmission
4 drive means
5 rotary position transducer, or angle transducer
6 buffering capacitor
7 supply line
8 control-system means
9 rechargeable battery/energy storage device
10 connecting line
11 control and display unit
12 indication means
13 input means
14 communication means
15 control electronics/control-system means
16 connecting line
17 line connection
18 housing
19 cooling means
20 rechargeable battery/energy supply means
21 outlet openings
22 air stream
100 tool appliance

What is claimed is:

1. An electrically operated tool appliance, comprising:
a rotatable tool head;
an electric motor drive configured to drive the rotatable tool head;
a control system configured to control the electric motor drive;
an energy supply configured to supply the electric motor drive with electrical energy; and
a first cooling mechanism configured to cool the electric motor drive and/or the control system, the first cooling mechanism defining a cooling capacity configured to be controlled independently of a rotational speed of the electric motor drive.

2. The tool appliance according to claim 1, further comprising:
a ventilation mechanism of the first cooling mechanism configured to generate an air flow through at least one region of the tool appliance.

3. The tool appliance according to claim 2, the first cooling mechanism further comprising:
air inlet openings for cooling air;
air outlet openings for cooling air; and
at least one flow channel for cooling air fluidly connecting the air inlet openings and the air outlet openings.

4. The tool appliance according to claim 3, wherein the flow channel is configured to enable cooling air to cool the electric motor drive and to cool the control system.

5. The tool appliance according to claim 3, wherein the flow channel is configured to enable cooling air to cool the energy supply.

6. The tool appliance according to claim 1, further comprising:
a second cooling mechanism configured to cool at least the electric motor drive.

7. The tool appliance according to claim 6, further comprising:
a drive shaft of the electric motor drive; and
a cooling element of the second cooling mechanism operatively coupled to the drive shaft.

8. The tool appliance according to claim 1, wherein the tool appliance is configured as a screwdriver or a blind-rivet setting devices.

9. The tool appliance according to claim 1, further comprising:
a further control system configured to control the cooling capacity of the first cooling mechanism in dependence on at least one operating parameter of the tool appliance.

10. The tool appliance according to claim 9, wherein the at least one operating parameter is at least one of a temperature of the electric motor drive, a temperature of the control system, an output power of the electric motor drive, a temperature of the energy supply, a rotational speed of the electric motor drive, a rotational speed of a drive shaft of the electric motor drive, and a motor power of the electric motor drive.
